(19) United States
(12) Patent Application Publication
(10) Pub. No.: US 2012/0022974 A1
(43) Pub. Date: Jan. 26, 2012

(54) MULTI-USER WORKS-OF-ART REGISTRY MANAGEMENT

(76) Inventor: Scott L. Shuster, Philadelphia, PA (US)

(21) Appl. No.: 13/190,017

(22) Filed: Jul. 25, 2011

Related U.S. Application Data
(60) Provisional application No. 61/400,176, filed on Jul. 23, 2010.

(51) Int. Cl. G06F 17/30; G06Q 30/00

(52) U.S. Cl. 705/27.1; 707/803; 707/E17.005

(57) ABSTRACT

In one embodiment, a registry of works of fine art is managed by a system having a computer communicatively connected to the Internet and to a database that stores the registry. The works of art may include numbered limited-edition prints and original one-off works. Management of the registry includes reading, writing, and modifying registry records. The computer controls access to the registry by Internet-based users. Works of art are shown to users organized by artist. Users may register to become members. The computer allows members to apply to register as owners of particular works of art, subject to approval. Members may view their collections. For any particular work of art, a member may, for example, request authentication of the work, put the work up for sale, transfer ownership of the work, print title documents, report the work lost or stolen, or flash ownership of the work to other users.

This application claims the benefit of the filing date of U.S. Provisional Application No. 61/400,176, filed on Jul. 23, 2010, the teachings of which are incorporated herein by reference in their entirety.

### BACKGROUND OF THE INVENTION

1. Field of the Invention

The invention relates, generally, to multi-user registries of uniquely identifiable works of art such as, for example, limited-edition prints, paintings, sculptures, photographs, and other works of art.

2. Description of the Related Art

There are numerous uniquely identifiable works of art, such as, for example, limited-edition prints, paintings, sculptures, photographs, and other two- and three-dimensional works of art created by artists. Aggregations of works of art, typically sharing a common creator or owner, are sometimes catalogued by the common owner or an organization associated with the artist. Note that owners may be corporeal (i.e., human) or organizations such as, for example, companies, museums, or universities. These owner and artist catalogs are typically (1) substantially limited to the works of art (a) belonging to the owner or (b) created by the particular artist, (2) limited in the scope of information available about the included works, and (3) not easily accessible to third parties who may be interested in acquiring particular works of art. Furthermore, the transaction costs for sales of works of art are often quite high due a plurality of factors such as, for example, the use of art-authentication experts, title experts, and transaction agents. One reason for the use of agents is to preserve the anonymity of sellers and/or buyers. This desire for anonymity makes it more difficult for buyers to contact potential sellers and for sellers to contact potential buyers of particular works of art.

### SUMMARY OF THE INVENTION

One embodiment of the invention can be a system comprising a processor. The processor is adapted to: (1) communicate with a database adapted to store a registry having records tracking uniquely identifiable items, (2) read, write, and modify records in the registry, (3) communicate with a plurality of users via a computer network, (4) provide, to the plurality of users, access to the registry, (5) display one or more records to one or more of the users, (6) allow at least one user to register as a member, (7) allow at least one member to add or update a record corresponding to a uniquely identifiable item, and (8) allow the at least one member to modify the display of the record corresponding to the uniquely identifiable item.

Another embodiment of the invention can be a processor-implemented method comprising: (1) communicating with a database adapted to store a registry having records tracking uniquely identifiable items, (2) performing at least one of reading, writing, and modifying records in the registry, (3) communicating with a plurality of users via a computer network, (4) providing, to the plurality of users, access to the registry, (5) displaying one or more records to one or more of the users, (6) allowing at least one user to register as a member, (7) allowing at least one member to add or update a record corresponding to a uniquely identifiable item, and (8) allowing the at least one member to modify the display of the record corresponding to the uniquely identifiable item.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a registry-management system in accordance with one embodiment of the present invention.

FIG. 2 shows a table structure for an exemplary table of artist records stored in the database of FIG. 1.

FIG. 3 shows a table structure for an exemplary table of work-of-art records stored in the database of FIG. 1.

FIG. 4 shows a table structure for an exemplary table of document records stored in the database of FIG. 1.

FIG. 5 shows a table structure for an exemplary table of edition records stored in the database of FIG. 1.

FIG. 6 shows a table structure for an exemplary table of edition-type records stored in the database of FIG. 1.

FIG. 7 shows a table structure for an exemplary table of member records stored in the database of FIG. 1.

FIG. 8 shows a table structure for an exemplary table of commercial-order records stored in the database of FIG. 1.

FIG. 9 shows a table structure for an exemplary table of registration records stored in the database of FIG. 1.

FIG. 10 shows a table structure for an exemplary table of role records stored in the database of FIG. 1.

FIG. 11 shows a table structure for an exemplary table of transfer records stored in the database of FIG. 1.

FIG. 12 shows a table structure for an exemplary table of service records stored in the database of FIG. 1.

FIG. 13 shows a flowchart, which shows a procedure for registering a specific work of art by the system of FIG. 1.

FIG. 14 shows an exemplary web page for works of art maintained by the system of FIG. 1 and displayed by an Internet portal of the system.

FIG. 15 shows an exemplary web page for a particular work of art maintained by the system of FIG. 1, as displayed by the Internet portal of the system.

FIG. 16 shows a flow chart for an exemplary implementation of the flashing-ownership feature in the system of FIG. 1.

### DETAILED DESCRIPTION OF THE INVENTION

One embodiment provides an automated system that permits (1) actual owners of works of art to signify to other parties their ownership of one or more particular works of art and (2) potential buyers to signify their interest in buying the works of art. The embodiment works by, among other ways, assigning a unique identification number to each piece of artwork registered with the system, which, after the ownership and authenticity of the work is verified by outside sources, operates as a trusted 13 much like an automobile Vehicle Identification Number (“VIN”)—for the work in question. Transactions may then be conducted anonymously and with confidence, since reference to the unique identification number provides not only a universal and unique identifier for a work of known origin, authenticity, and ownership, but also, when needed, provides a way to refer to the work without necessitating the divulging of the identity of the owner offering the work for sale.

In one embodiment, the automated system includes an interconnected network of general-purpose computers, such as the Internet. The network connects a central database to a plurality of computers, wherein the database stores ownership and authentication information regarding one or more works of art. The database contains information concerning the work itself, such as, e.g., the work's title, a description of the work, the artist or creator of the work, whether the work is one of a kind or one of a series of authorized reproductions, and if so, how many reproductions are part of the series, and one or more digital photographs or other images of the work (“artwork data”). The database also includes information concerning the chain of title or ownership for the work, such as, e.g., the current and former owners' names and contact information, or, in case the owner desires anonymity, an owner's agent's name and contact information (“ownership data”). The database includes available data about the purchase and transaction history of the piece in question, such as, e.g., prior sales or transaction dates, transaction types (sale, installment sale, loan, gift, bequest, inheritance, etc.), and any monetary figures involved (“transaction data”). Copies of available transaction documents may be saved for public or private viewing (“transaction documents”).

Artwork data, ownership data, and transaction data may be authenticated through one or more of several types of independent authenticators, typically employing the services of one or more third-party validators, such as foundations, museums, galleries, auction houses, art traders, art historians, forensic scientists, attorneys and other professionals specially trained in the relevant fields. In one embodiment, information concerning the methods by which the artist data, ownership data, and transaction data were validated is also stored in the database—such as the date on which the third-party validator was contacted for validation purposes and the decision rendered by the third-party validator (“validation data”). One or more of the actual documents used or created in the validation process (“validation documents”) may also be stored in the database.

The system may be used, for example, by third parties, such as members of the public, who are granted access to at least selected portions of the database and system through a computer network, such as the Internet. Additional users may also include authenticated and registered members. Various pricing plans for corresponding types of users may be used to generate revenue from the system. For example, members may be charged for each work of art they want to register or members may pay a subscription fee, where a member can register a set number of works or an unlimited number of works for a given periodic fee.

Users of the system may register their ownership of a specific work with the system, upload images of the work, and upload one or more of transaction data, validation data, transaction documents, and validation documents. Users may also search the database for ownership data on specific works and view photographs or other images uploaded onto the system. Users may contact one another through any messaging technology (e.g., system-specific or Internet-wide email, short-messaging service technology, etc.). Users may place bids to purchase, or make offers to sell, particular works to other users.

The system allows a potential seller to signal to one or more other users, such as potential buyers, that the potential seller is, in fact, the true owner of the work in question. The owner may have his or her database listings for the work of art in question appear on the screen of users in a special format—by, for example, flashing, bolding, underlining, italicizing, or highlighting the listing of the work on the screen. Note that other methods for altering the appearance of a particular listing may be used. This feature—referred to as “flashing ownership”—enables one party to prove that it, in fact, controls the listing of the work in question on the database. Flashing ownership may be useful during negotiations between potential sellers and buyers to verify ownership of a given work. The availability of the flashing-ownership feature for users is restricted to the user responsible for the database entry for the work in question. The flashing-ownership feature's alteration of appearance may be turned on at will and may be set to either persist for a fixed period of time, or be terminated manually.

Some embodiments allow a user to challenge the title to a specific work of art. Some embodiments include marking works of art with a unique radiofrequency identification (RFID). Some embodiments include the ability to report a registered work as being lost or stolen. Some embodiments include the ability to enroll in an insurance protection plan for a registered work.

RFID tags are particularly useful for original one-off works of art. Unlike limited editions, where each edition is uniquely numbered, an original one-off work of art is not typically given a serial number. In one embodiment, an RFID tag is associated (by, for example, attachment or embedding) with a corresponding original one-off work of art. The RFID tag has a unique identification number which allows for the association of a unique identifying description (UID) with the corresponding original work of art. The UID provides descriptive information about the work of art. The RFID tag may itself incorporate the UID so that scanning the RFID with an appropriate reader will provide a readout of the UID and allow a user to immediately see if the UID information matches the tagged object.

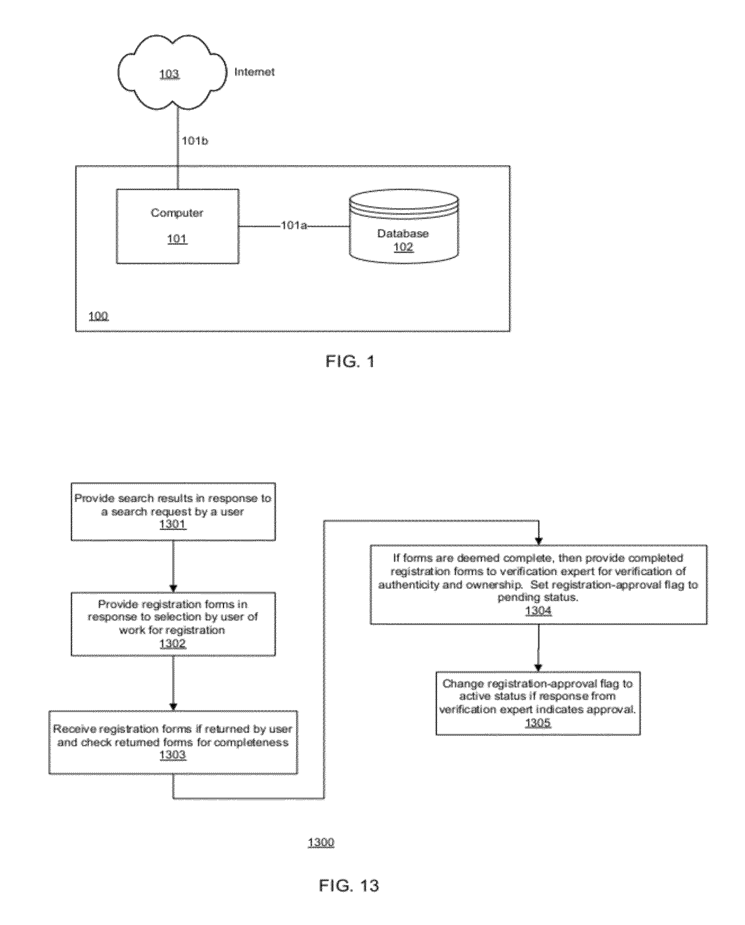

FIG. 1 shows registry-management system 100 in accordance with one embodiment of the present invention. System 100 comprises computer 101 connected via path 101a to database 102. Computer 101 may be implemented as a single device or as a distributed device having a plurality of machines. Similarly, database 102 may be implemented on a single device or on a distributed-device system. Computer 101 manages the registry of works of art, which is maintained on database 102. Computer 101 is also connected to Internet 103 via path 101b. Computer 101 controls networked access to the registry on database 102 by users using computers connected to the Internet. Computer 101 may present information for all the artists contained in database 102 on one Internet portal, such as, for example, a website. Alternatively, computer 101 may operate separate and distinct portals for one or more of the artists contained in database 102, which allows users to focus on the works of one artist at a time. A separate portal for a particular artist, or subset of artists, allows for customization of the look and feel of the particular portal to, for example, convey a sense of the corresponding artist or subset. Note that the records for multiple artists having distinct web sites may still be maintained by database 102 in one database table. Database 102 may comprise multiple database tables, as described below.

Note that database 102 may be implemented in any one of a number of technologies for implementing database systems. Database 102 may be implemented in either object-oriented database systems or in non-object-oriented database systems. To that extent, the term “record,” which commonly denotes the non-object-oriented database paradigm, may be used interchangeably herein with the term “object.” Any “methods” (as that term is used in the object-oriented programming paradigm) associated with one or more objects should be considered to be included with the record in question, as though the database were carried out in object-oriented technologies.

FIG. 2 shows table structure 200 for an exemplary table of artist records (not shown) stored in database 102 of FIG. 1. Table structure 200 shows the field names and field types for the fields of the artist-records table and also shows sample record data. The fields of an artist record may include (1) integer field “ID,” (2) text fields “First Name,” “Last Name,” “Site ID,” and “Site Title,” and (3) pointer field “HomeImage1.” “ID” uniquely identifies each artist. Note that, in general, the “ID” field of a table allows linking the information in that table to records in other tables, as would be appreciated by a person of ordinary skill in the art of relational database management. “First Name” and “Last Name” store the artist's first and last names, respectively. “Site ID” and “Site Title” are, respectively, the web address (or universal resource locator (“URL”)) and web-page title for the custom web page, if any, for the artist. “HomeImage1” is a pointer to a picture of the artist for display on the custom web page or, as otherwise appropriate, by system 100.

FIG. 3 shows table structure 300 for an exemplary table of work-of-art records (not shown) stored in database 102 of FIG. 1. The fields for an artwork record may include (1) integer fields “ID,” “Year,” “Catalog Number,” and “Artist ID,” (2) text fields “Title,” “Media,” and “Notes,” and (3) pointer field “Photo.” “ID” uniquely identifies each work of art. “Title” is the title of the work. “Media” describes the work's media (e.g., oil on canvas, charcoal on paper, lithograph, etc.). “Year” is the year of creation of the work. “Catalog Number” is a reference number for the work from an official artist's catalog that may, for example, be maintained by a corresponding foundation. “Artist ID” is the corresponding “ID” for the artist from the table of artist records, as described by table structure 200. “Notes” is for any notes about the work. “Photo” is a pointer or link to a photograph of the work of art.

FIG. 4 shows table structure 400 for an exemplary table of document records (not shown) stored in database 102 of FIG. 1. The table of document records stores information about various registration-related documents that users may upload to database 102, such as, for example, registration documents, ownership-contest documents, and transaction documents. Note that a particular registration may be associated with multiple documents. Also note that a particular work of art edition may be associated with multiple registrations since the work of art may have a succession of registered owners. Users may provide various designations to their documents, including whether they are public or confidential. The fields for a document record may include (1) integer fields “ID,” “Registration ID,” and “Document Type,” (2) text fields “Source,” “File Name,” “File Type,” and “URL,” (3) date field “Date,” (4) Boolean fields “Confidential” and “IsImage,” (5) hexadecimal (“hex”) field “Key,” and (6) pointer field “Document.”

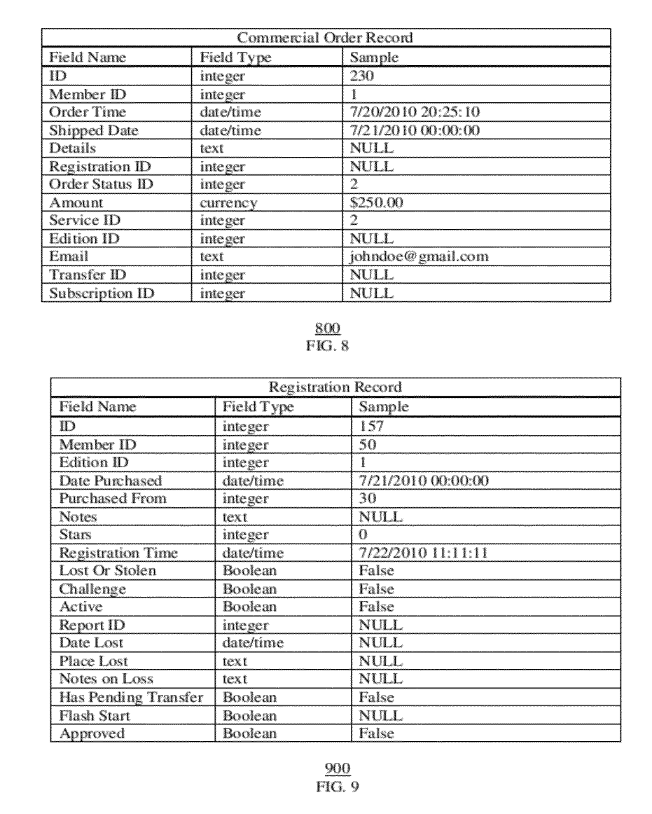

“ID” uniquely identifies each document. “Registration ID” identifies the “ID” field of a corresponding registration record for the document, as shown in table structure 900 of FIG. 9, below. “Source” stores information about the source from which the document came (e.g., the user who uploaded the document). “Date” is the document upload date. Note that a date/time field, or another type of field, may be used to store date information instead of a date type field. “Document” is a pointer to an electronic copy of the document itself stored in database 102. “File Name” is the file name of the document, as recorded by the relevant operating system. “File Type” describes the document type (e.g., DOC, PDF, JPEG, GIF, etc.). “Confidential” indicates whether the document is flagged as confidential or public. “IsImage” indicates whether the document is an image file (e.g., JPEG or GIF). “Document Type” characterizes the type of the document (e.g., sales receipt, authentication report, etc.). “Key” is an encryption key that may be used to secure the document by, for example, encrypting the stored document to limit access to the document to only authorized users. “URL” is a uniform resource locator (URL) indicating where on the system's Internet portal the document may be viewed or otherwise accessed by users.

As noted above, multiple document records may be associated with a single work of art, for use in several situations. For example, the same work might be owned by several owners over time, where different owner records would be used to store this information for the single work. As another example, during ownership challenges, multiple records store information corresponding to multiple potential owners for a single work. Further, multiple documents may be used to register the work or contest its ownership. As such, as noted above, each document record contains a field for storing the registration ID number that was assigned to a corresponding registration record when the registration record was created.

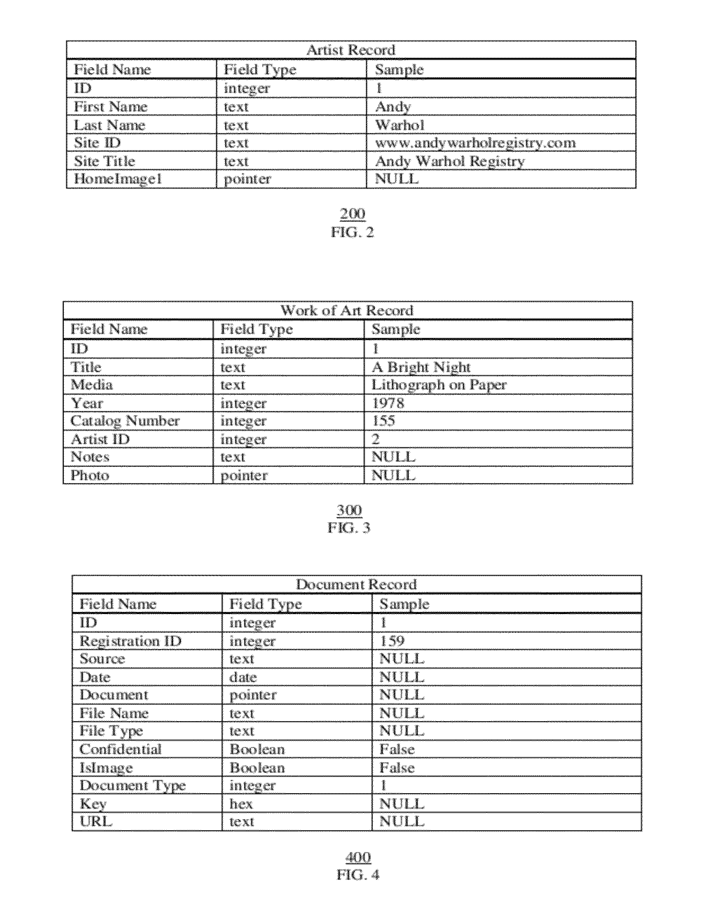

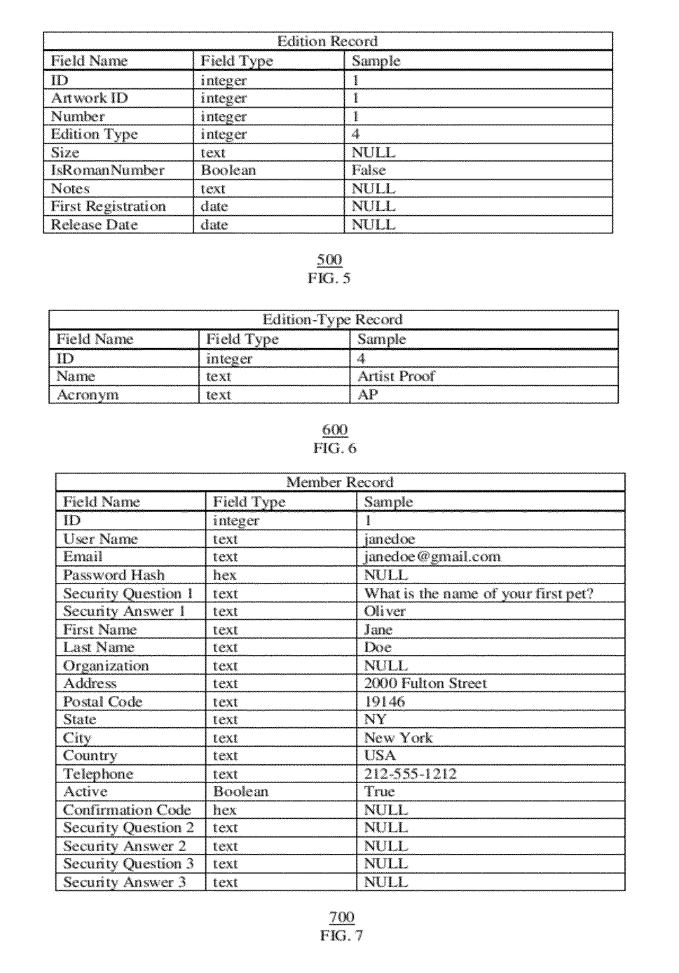

FIG. 5 shows table structure 500 for an exemplary table of edition records (not shown) stored in database 102 of FIG. 1. The table of edition records stores information about specific editions of a work of art, such as numbered prints of a limited-edition print. The fields for an edition record may include (1) integer fields “ID,” “Artwork ID,” “Number,” and “Edition Type,” (2) text fields “Size” and “Notes,” (3) Boolean field “IsRomanNumber,” and (4) date fields “First Registration” and “Release Date.”

“ID” uniquely identifies each edition of a particular work of art. “Artwork ID” identifies the “ID” field of the corresponding work of art, as shown in table structure 300 of FIG. 3. “Number” is the official edition number used to identify the edition outside system 100, such as, for example, by an artistic-foundation catalog for the artist. “Edition Type” indicates the type of edition, such as, for example, limited, signed, or regular. “Edition Type” corresponds to the “ID” field of table structure 600 of FIG. 6, described below. “Size” is the size dimensions for the edition. “IsRomanNumber” indicates whether the corresponding “Number” should be shown as a Roman numeral since some catalogs use Roman numerals rather than Arabic numerals to designate editions. “Notes” is for any notes about the edition. “First Registration” indicates the date, if any, that an edition was first registered. “Release Date” indicates the date, if any, that a registration of an edition was released by its registered owner.

FIG. 6 shows table structure 600 for an exemplary table of edition-type records (not shown) stored in database 102 of FIG. 1. The table of edition-type records stores identifications of types of editions, such as, for example, regular proof, artist's proof, or printer's proof. The fields for an edition-type record may include (1) integer field “ID” and (2) text fields “Name” and “Acronym.” “ID” uniquely identifies each edition type. “Name” provides a name for a particular edition type (e.g., artist proof, printer proof, etc.). “Acronym” provides an abbreviation for the name of the particular edition type.

FIG. 7 shows table structure 700 for an exemplary table of member records (not shown) stored in database 102 of FIG. 1. The table of member records stores information about users of system 100 who registered as members. Typical members are owners of artwork whose registration is maintained by system 100. The fields for a member record may include (1) integer field “ID,” (2) text fields “User Name,” “Email,” “Security Question 1,” “Security Answer 1,” “First Name,” “Last Name,” “Organization,” “Address,” “Postal Code,” “State,” “City,” “Country,” “Telephone,” “Security Question 2,” “Security Answer 2,” “Security Question 3,” and “Security Answer 3,” (3) hex fields “Password Hash” and “Confirmation Code,” and (4) Boolean field “Active.”

“ID” uniquely identifies each member record. “User Name” stores a username that the member may use to log into a secure portion of system 100. “Email” is an email address for the member. “Password Hash” is used to authenticate the member's login password so that the actual password does not need to be stored by system 100. “Security Question [1/2/3]” and “Security Answer [1/2/3]” are security questions and corresponding member-provided answers that can be used to verify the identity of a member if, for example, the member forgets his or her password. “First Name” and “Last Name” store the member's first and last names, respectively. “Organization” stores the name of the organization, if any, affiliated with the member. “Address,” “Postal Code,” “State,” “City,” and “Country” store corresponding elements of a mailing address for the member. “Telephone” provides a telephone number for the member. “Active” indicates whether the corresponding user is an active member of system 100. “Confirmation Code” stores a confirmation code.

FIG. 8 shows table structure 800 for an exemplary table of commercial-order records (not shown) stored in database 102 of FIG. 1. The table of commercial-order records stores information about commercial orders placed by users of system 100. Commercial orders include, for example, an order for a report on a specific work of art or edition, an order to buy or renew a membership subscription, etc. The fields for a commercial-order record may include (1) integer fields “ID,” “Member ID,” “Registration ID,” “Order Status ID,” “Service ID,” “Edition ID,” “Transfer ID,” and “Subscription ID,” (2) date/time fields “Order Time,” and “Shipped Date,” (3) text fields “Details,” and “Email,” and (4) currency field “Amount.”

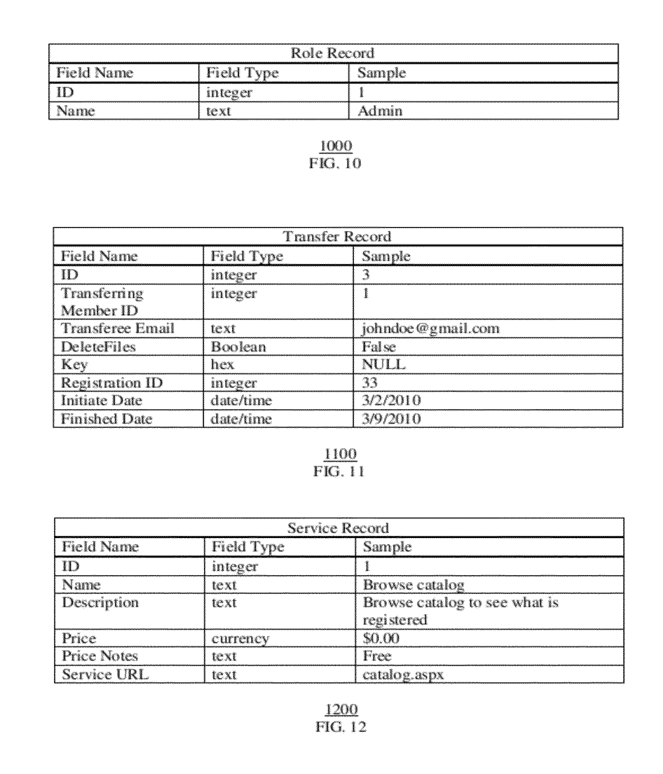

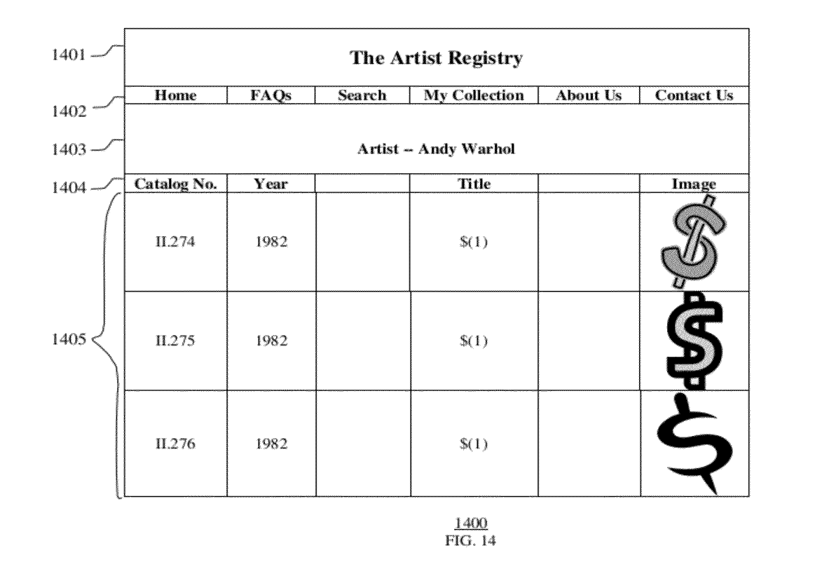

“ID” uniquely identifies a commercial order. “Member ID” identifies the “ID” of the corresponding member in the member record table, as described above in reference to table structure 700 of FIG. 7. Note that this might be blank since non-member users may also place commercial orders. In general, it should be noted that most of the fields in most of the tables may be empty for a particular record. Typically, the one field that should not be empty for any record in a table is the “ID” field. “Order Time” provides the time and date that the commercial order was placed. “Shipped Date” provides the date the commercial order was fulfilled or shipped. “Details” provides any available details about the commercial order. “Registration ID” indicates a corresponding “ID” field from a registration record table, such as described in reference to table structure 900 of FIG. 9. “Order Status ID” corresponds to a field in an order status table (not shown) that describes the status of the order. “Amount” provides the amount of money that was charged to the user for the commercial order. “Service ID” identifies a corresponding “ID” field from a service record table, such as described below in reference to table structure 1200 of FIG. 12, where the service record identifies the commercial service ordered. “Edition ID” identifies the corresponding edition by referencing the “ID” field of the edition records table described above in reference to table structure 500 of FIG. 5. “Email” provides an email address associated with the user that placed the commercial order. The “Email” field is useful for commercial orders placed by non-member users. “Transfer ID” identifies a corresponding “ID” field from a transfer record table, such as described below in referenced to table structure 1100 of FIG. 11. “Subscription ID” identifies a corresponding “ID” from a subscription record table (not shown), used for storing information about subscriptions to services provided by system 100.

FIG. 9 shows table structure 900 for an exemplary table of registration records (not shown) stored in database 102 of FIG. 1. The table of registration records stores information about registrations by members of particular works of arts and editions. The fields for a registration record may include (1) integer fields “ID,” “Member ID,” “Edition ID,” “Purchased From,” “Stars,” and “Report ID,” (2) date/time fields “Date Purchased,” “Registration Time,” and “Date Lost,” (3) text fields “Notes,” “Place Lost,” and “Notes on Loss,” and (4) Boolean fields “Lost or Stolen,” “Challenge,” “Active,” “Has Pending Transfer,” “Flash Start,” and “Approved.”

“ID” uniquely identifies the registration record. “Member ID” identifies the corresponding member by referencing the “ID” field of the member records table, as described above in reference to table structure 700 of FIG. 7. “Edition ID” identifies the corresponding edition by referencing the “ID” field of the edition records table, as described above in reference to table structure 500 of FIG. 5. “Date Purchased” identifies the date the corresponding edition of the work of art was purchased. “Purchased From” identifies the member the edition was purchased from, if available. “Notes” stores any additional notes about the acquisition of the corresponding edition. “Stars” identifies an automatically generated confidence indicator showing the confidence in the validity of the registration. For example, a registration by a new member that is initiated without any supporting documentation would have a low confidence rating and, consequently, get few stars. On the other hand, a registration by a veteran user having many registered works in system 100, where the registration is accompanied by various supporting documents, would have a high confidence rating and, consequently, get many stars. Note that the stars provide an initial indication of system-determined confidence to the validator and may be later modified by the validator or other authorized users of system 100. “Registration Time” records the time that the registration was completed.

“Lost or Stolen” indicates whether the edition has been reported as lost or stolen by the member owner. “Challenge” indicates whether another user has challenged the registered member owner's ownership of the work of art. “Active” indicates whether the registration is active or has expired. “Report ID” identifies a report about the edition or work of art, if purchased by a user, by referencing the “ID” field of a report records table (not shown). “Date Lost” identifies the date, if any, that the edition is believed to have been lost or stolen. “Place Lost” identifies the location, of any, from where the edition was lost or stolen. “Notes on Loss” provides any additional information regarding a reportedly lost or stolen edition of a work of art. “Has Pending Transfer” indicates whether the corresponding edition is in the process of being sold or otherwise undergoing an ownership transfer. “Flash Start” indicates whether the corresponding edition should be highlighted to users of system 100, in accordance with the flashing-ownership feature described elsewhere herein. “Approved” indicates whether the operator of system 100 has approved the purported owner's claim of ownership of the edition. If a registration record is marked as approved, then the registration is considered complete and can, consequently, be displayed on the web site corresponding to system 100. If a registration record is not yet approved, then the registration record will either not be displayed or be displayed with an indication that approval is pending.

FIG. 10 shows table structure 1000 for an exemplary table of role records (not shown) stored in database 102 of FIG. 1. The table of role records stores information about roles or statuses available to users of system 100. Available roles include, for example, guest, member, and administrator. The fields for a role record may include (1) integer field “ID” and (2) text field “Name.”

“ID” uniquely identifies a role. “Name” provides the description of the particular role. The role records table is used for administrative purposes by system 100.

FIG. 11 shows table structure 1100 for an exemplary table of transfer records (not shown) stored in database 102 of FIG. 1. The table of transfer records stores information about transfers of editions of works of art effectuated using system 100. The fields for a transfer record may include (1) integer fields “ID,” “Transferring Member ID,” and “Registration ID,” (2) text field “Transferee Email,” (3) Boolean field “DeleteFiles,” (4) hex field “Key,” and (5) date/time fields “Initiate Date” and “Finished Date.”

“ID” uniquely identifies a transfer record. “Transferring Member ID” identifies the transferring member by referencing the “ID” field of the member records table, as described above in reference to table structure 700 of FIG. 7. “Transferee Email” provides the email address of the transferee of the corresponding work of art, which is useful for transfer where the transferee is not a member of system 100. “DeleteFiles” indicates whether the transferring member wishes to have deleted the documents in database 102 associated with the transferring member's ownership of the edition after the transaction is completed. “Key” stores a security key that may be used to encrypt communications associated with the transfer. “Registration ID” identifies the corresponding registration record for the edition by referencing the “ID” field of the registration records table, as described in reference to table structure 900 of FIG. 9. “Initiate Date” records the date the transfer was initiated. “Finished Date” records the date the transfer was completed.

It should be noted that there are several ways in which a transfer may be effectuated using system 100. For example, a registered owner may first release the owner's registration of a work to be transferred. System 100 may continue to show the work as registered for a number of days or weeks so as to avoid signaling that the work is being transferred. The transferring member may then send an email to the transferee, the email containing a URL to a page where the transferee can register the work as the transferee's. In one alternative, system 100 sends an email to the transferee, the email containing a URL to a page where the transferee can register the work as the transferee's.

FIG. 12 shows table structure 1200 for an exemplary table of service records (not shown) stored in database 102 of FIG. 1. The table of service records stores information about different services offered to users of system 100 such as, for example, browsing the catalog, reporting a work lost or stolen, or buying a subscription. The fields for a service record may include (1) integer field “ID,” (2) text fields “Name,” “Description,” “Price Notes,” and “Service URL,” and (3) currency field “Price.”

“ID” uniquely identifies a service record. “Name” records the name for the particular service. “Description” provides a longer description of the service corresponding to the service record. “Price” stores the price charged to a user for the corresponding service. “Price Notes” stores any notes associated with the price charged. “Service URL” stores a URL for accessing the corresponding service on the Internet portal for system 100 of FIG. 1.

FIG. 13 shows flowchart 1300, which shows a procedure for registering a specific work of art by system 100 of FIG. 1. In response to a search request by a user (not shown), search results of works responsive to the search criteria are provided to the user (step 1301). Next, if the user selects a work for registration, then registration forms are provided to the user in response to the selection (step 1302). If the user returns the registration forms, then they are received and checked for completeness (step 1303). If the forms are deemed complete, then the completed registration forms are provided to a verification expert for verification of authenticity and ownership (step 1304). In addition, the registration approval flag in the registration table is set to pending status (step 1304). If a response received from the verification expert indicates approval of the registration, then the registration-approval flag is changed to active status (step 1305).

System 100 allows a user to challenge the claimed ownership of a work of art. If the challenger finds a work listed by system 100 whose ownership the challenger wants to challenge, then the challenger indicates the desire to challenge ownership by, for example, selecting a challenge-ownership button corresponding to the work. This selection initiates a process that includes requesting information and documentation from the challenger, marking the ownership status of the work as challenged and sending requests for documentation and/or information to the registered owner. The challenge service may require the payment of a fee by the challenger. System 100 is adapted to receive documents from the registered owner, the challenger, as well as third parties. Relevant documents are then provided to an arbitrator who determines the true ownership based on the submitted documents and information. Once a determination is made, the ownership status is updated, if necessary, and the challenged status is removed from the registration.

System 100 may provide clickable buttons on its Internet gateway to allow a member to perform actions such as request authentication of a work of art from a third-party validator or buy insurance for the work of art. System 100 may provide a simple Internet-based mechanism for transferring registered ownership of a work of art from a member to another member or a non-member user, where the mechanism includes the transfer of funds from the buyer to the seller. System 100 may provide an Internet-based mechanism to allow a registered member to report a registered work of art as lost or stolen. The information provided by a member regarding a lost or stolen work of art may be made available to one or more of law-enforcement authorities, members of system 100, non-member users of system 100, and the general public. System 100 may also provide a means for members, users, and or the general public to contact the registered owner who reported a work of art as lost or stolen in order to, for example, provide information to help retrieve the work.

FIG. 14 shows exemplary web page 1400 for works of art maintained by system 100 of FIG. 1 and displayed by an Internet portal of system 100. Web page 1400 includes title section 1401, page header 1402, artist identifier 1403, catalog header 1404, and catalog entries 1405. Title section 1401 identifies a mark affiliated with web page 1400 (e.g., “The Artist Registry”). Page header 1402 includes links to the site home, frequently asked questions (“FAQ”), a search feature, a “My Collection” page, an about-us page, and a contact-us page. Artist identifier 1403 identifies the artist whose works appear in the currently visible catalog (e.g., “Andy Warhol”). As indicated by catalog header 1404, a record in catalog entries 1405 may include a catalog number from the official artist catalog, a year of creation, a title, and a small photograph of the work. It should be noted that although “$(1)” is the title of a work by Andy Warhol, that work is not shown in FIG. 14. Rather, other sample graphics are shown. Clicking on any individual record in catalog entries 1405 will bring up a page with more detailed information about that work. It should be noted that the Internet portal may include ads (not shown). Such ads may be targeted to a user depending on the particular artist or types of works being displayed to the user.

Selecting the “My Collection” tab takes a registered member to a page (not shown) listing the works of art registered to the member. If the member is accessing system 100 via an Internet portal dedicated to one artist, the “My Collection” listing may nevertheless include works registered to the member in system 100 that were created by other artists. The listing of works of art in “My Collection” may be in the form of a table listing the artist, the title, catalog number, edition number, type, status, and available actions.

Actions for a work of art available to the registered owner/member may include transfer of ownership, report as lost or stolen, flash ownership, update/view information, print title document, insure the work of art, sell the work of art, and request authentication of the work of art. Selecting an action item will take a member to a new page where relevant available information will be used to auto-populate the appropriate fields. For example, if a member selects the sell action option, and if the member selects Christie's as the sales agent, then the member will be taken to an appropriate page on the Christie's Internet portal and system 100, which will auto-populate the fields for owner and artwork information. System 100 may automatically collect a referral fee from the selected sales agent.

It should be noted that the actions shown as available to a particular user may be varied by system 100 depending on both the user and the status of the work. Thus, for example, a non-owner, non-member user may have the action option only of registering the work. A non-owner member user may also have the option of challenging the ownership of the work The owner of the work may have the additional options described above. It should also be noted that the statuses shown to an owner/member may be different than those shown to a non-member user or non-owner member. For example, non-owners may see only whether a work is registered or not, while the registered owner may see, for example, whether the registration is active, inactive, pending, and/or approved. The displayed statuses may also be varied depending on whether a member is viewing a general works-of-art page or the member's “My Collection” page.

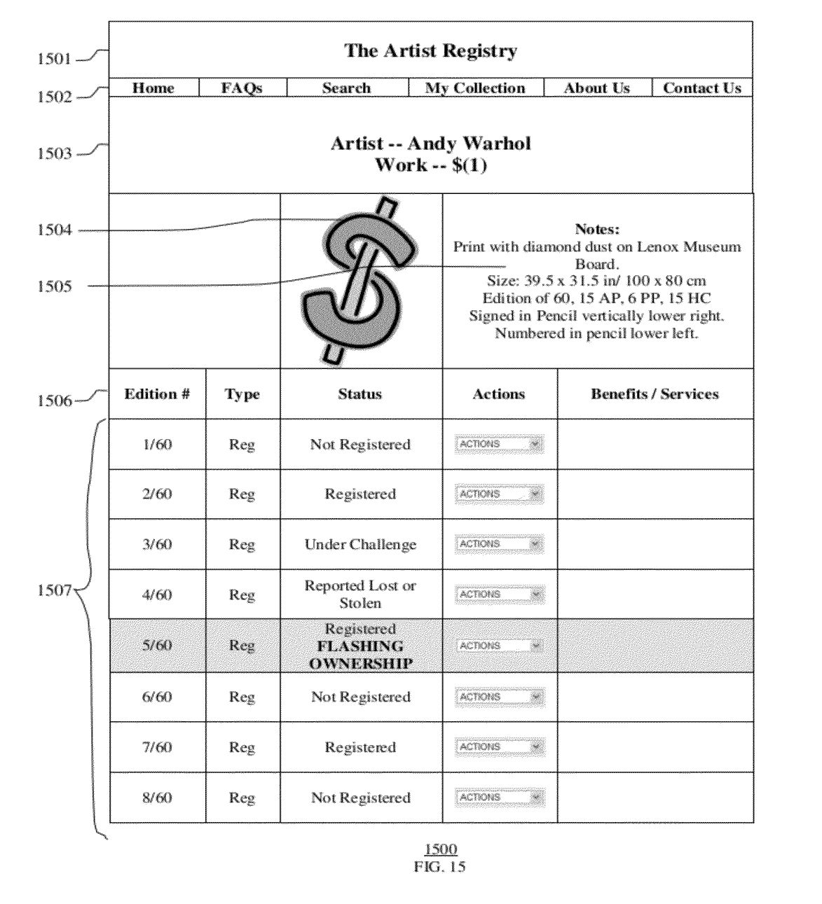

FIG. 15 shows exemplary web page 1500 for a particular work of art maintained by system 100 of FIG. 1, as displayed by the Internet portal of system 100. Web page 1500 includes title section 1501, page header 1502, artist and work identifier 1503, work representation 1504, notes section 1505, editions header 1506, and editions listing 1507. Title section 1501 identifies a mark associated with web page 1500. Page header 1502 includes links to the site home, FAQ, search feature, the “My Collection” page, the about-us page, and the contact-us page. Artist and work identifier 1503 identifies the particular artist and work shown. Work representation 1504 includes a small photograph of the work. Notes section 1505 includes information about the work, such as medium, size, and editions information. As indicated by editions header 1506, editions listings 1507 may include an edition number, an edition type, a registration status, an available actions section, and a benefits/services listing. Registration statuses may include, for example, “Registered,” “Not Registered,” “Under Challenge,” and “Reported Lost or Stolen.” The available actions section may be in the form of a drop-down box allowing the selection of various actions, as described elsewhere herein. If the flashing-ownership feature is activated, then a corresponding edition listing would be shown as flashing (not shown), or otherwise highlighted, such as the gray highlighting of edition 5/60 shown in FIG. 15. Note that the appearance of flashing may be achieved by, for example, relatively rapidly cycling the background and/or text of a record through two or more colors or shades. In addition, the status of a flashing edition may be changed, as shown for edition 5/60 in FIG. 15.

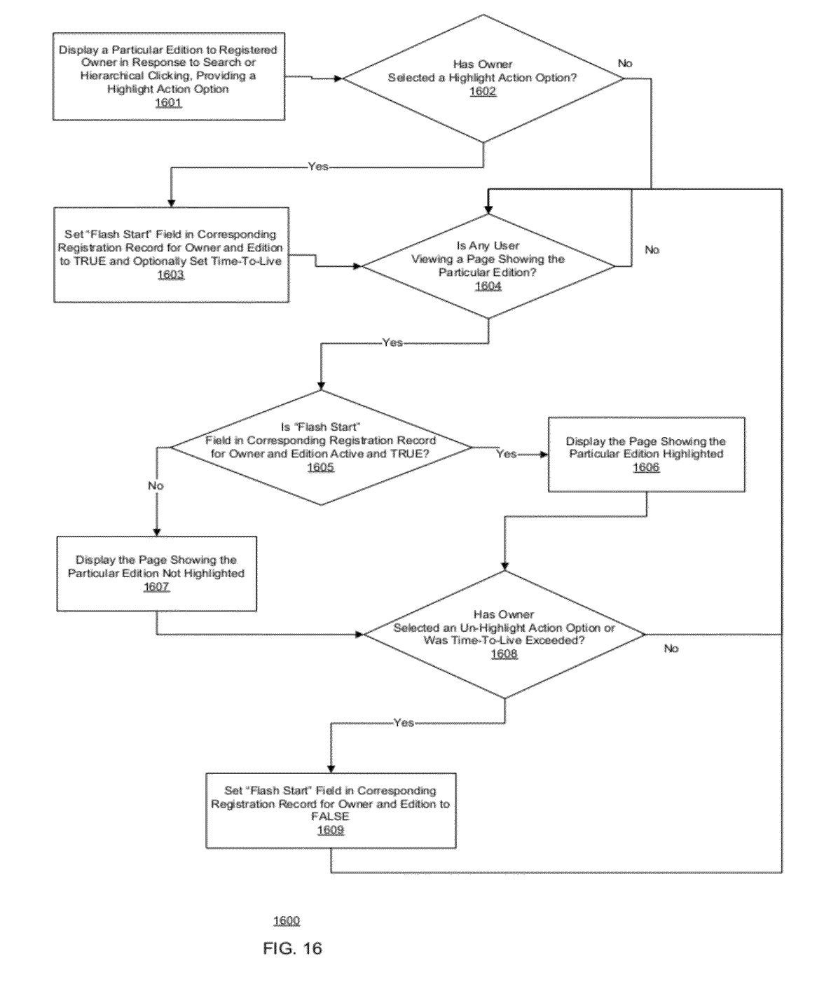

FIG. 16 shows flow chart 1600 for an exemplary implementation of the flashing-ownership feature in system 100 of FIG. 1. In response to, for example, a search or hierarchical clicking through the Internet portal of system 100, a particular edition is displayed to the registered owner of the edition, where the display provides a highlight action option (step 1601). The edition may be displayed by itself or together with other works and/or editions. System 100 determines if the owner has selected the highlight action option (step 1602). If the determination of step 1602 is a yes, then the “Flash Start” field in the registration record corresponding to the owner and edition is set to TRUE (step 1603). Optionally, a time-to-live parameter is set for the flashing-ownership feature (step 1603).

Regardless of the determination of step 1602, it is next determined whether any user is viewing a page of the Internet portal that shows the particular edition (step 1604). If the determination of step 1604 is a no, then the process returns again to step 1604 (step 1604). If the determination of step 1604 is a yes, then it is determined whether the “Flash Start” field in the registration record for the owner and edition corresponding to the particular edition is active and TRUE (step 1605). If the determination of step 1605 is a yes, then the page is displayed showing the particular edition highlighted (step 1606). If, on the other hand, the determination of step 1605 is a no, then the page is displayed showing the particular edition not highlighted (step 1607).

After either step 1606 or 1607, it is determined whether either (i) the owner has selected an un-highlight action option for the edition or (ii) the time-to-live for the edition has expired (step 1608). If the determination of step 1608 is a no, then the process returns to step 1604. If the determination of step 1608 is a yes, then the “Flash Start” in the registration record corresponding to the owner and edition is set to FALSE (step 1609) and the process returns to step 1604. It should be noted that the above describes one exemplary process for implementing the flashing-ownership feature, and various modifications are possible without deviating from the scope of the invention.

System 100 of FIG. 1 has been described as having tables with table structures using particular fields names and types. Alternative embodiments of system 100 have different field names, field types, fields, and/or tables. Multiple ways exist to represent and store data in a database system, such as database 102.

Embodiments may be in the form of methods and apparatuses for practicing those methods. Embodiments may also be in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. Embodiments may be in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor, the program code segments combine with the processor to provide a unique device that operates analogously to specific logic circuits.

It will be appreciated by those skilled in the art that although the functional components of the exemplary embodiments of the system of the present invention described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, the system of the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, or Apple Safari™). Thus, the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Microsoft Windows NT/2000™ or UNIX.

Components of a system consistent with embodiments of the invention may include mobile and non-mobile devices. Mobile devices that may be employed in the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to the present invention. These personal computers may run the Unix, Microsoft Windows NT/2000™ or Windows 95/98/NT/ME/CE/2000/XP/Vista/7™ operating systems. The aforesaid functional components of a system according to the present invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality (e.g., as part of a system operated by an art dealer or broker for the art work bought and/or sold by that dealer or broker).

In one embodiment, source code may be written in an object-oriented programming language using relational databases. Such an embodiment may include the use of programming languages such as C++ and toolsets such as Microsoft's .Net™ framework. Other programming languages that may be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The terms “computer” or “system” can be used to refer to more than a single computing device, e.g., multiple personal computers, or one or more personal computers in conjunction with one or more other devices, such as a router, hub, packet-inspection appliance, firewall, etc.

A system consistent with the present invention may process payment for orders by interacting with established payment networks, e.g., the Automated Clearing House (ACH) to provide payment options such as ACH debits, credit or procurement card payments, and/or paper checks. Payment by a payer system user using a credit or procurement card may also be effected, to be processed by Internet or other means. In this scenario, additional security levels may be included, e.g., for initiating credit or debit card payments and approving credit or debit card payments, and such appropriate payment-card processing functionality as may be appropriate may be included, as well.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Although the invention has been set forth in terms of the exemplary embodiments described herein and illustrated in the attached documents, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the invention be interpreted as encompassing all alterations, modifications, or alternative embodiments and applications as fall within the true spirit and scope of this disclosure.

References herein to the verb “to set” and its variations in reference to values of fields do not necessarily require an active step and may include leaving a field value unchanged if its previous value is the desired value. Setting a value may nevertheless include performing an active step even if the previous or default value is the desired value.

Exemplary embodiments have been described wherein particular entities (a.k.a. modules) perform particular functions. However, the particular functions may be performed by any suitable entity and are not restricted to being performed by the particular entities named in the exemplary embodiments.

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

The use of figure numbers and/or figure reference labels in the claims is intended to identify one or more possible embodiments of the claimed subject matter in order to facilitate the interpretation of the claims. Such use is not to be construed as limiting the scope of those claims to the embodiments shown in the corresponding figures.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. A system comprising a processor, the processor adapted to:
communicate with a database adapted to store a registry having records tracking uniquely identifiable items;
read, write, and modify records in the registry;
communicate with a plurality of users via a computer network;
provide, to the plurality of users, access to the registry;
display one or more records to one or more of the users;
allow at least one user to register as a member;
allow at least one member to add or update a record corresponding to a uniquely identifiable item; and
allow the at least one member to modify the display of the record corresponding to the uniquely identifiable item.

2. The system of claim 1, wherein the processor is further adapted to allow the at least one member to initiate a request for authentication of the uniquely identifiable item by a third-party.

3. The system of claim 1, wherein the processor is further adapted to allow the at least one member to provide access to one or more documents relating to the uniquely identifiable item to a third-party.

4. The system of claim 1, wherein the processor is further adapted to allow the at least one member to contact a sales agent via the computer network to initiate a sale of the uniquely identifiable item.

5. The system of claim 4, wherein the initiation of the sale of the uniquely identifiable item comprises automatically populating at least one field on an Internet site of the sales agent.

6. The system of claim 1, wherein the processor is further adapted to allow the at least one member to identify the uniquely identifiable item as lost or stolen.

7. The system of claim 1, wherein the processor is further adapted to allow the at least one member to request insurance coverage from an insurance provider via the computer network for the uniquely identifiable item.

8. The system of claim 1, wherein the modification of the display of the record comprises having the background of the display of the record flash two or more different colors.

9. The system of claim 1, wherein the modification of the display of the record is terminated substantially immediately in response to a termination request received from the at least one member.

10. The system of claim 1, wherein:
the display of the record corresponding to the uniquely identifiable item includes a status designation; and
the modification of the display of the record comprises changing the status designation for the record to indicate a flashing of ownership.

11. A processor-implemented method comprising:
communicating with a database adapted to store a registry having records tracking uniquely identifiable items;
performing at least one of reading, writing, and modifying records in the registry;
communicating with a plurality of users via a computer network;
providing, to the plurality of users, access to the registry;
displaying one or more records to one or more of the users;
allowing at least one user to register as a member;
allowing at least one member to add or update a record corresponding to a uniquely identifiable item; and
allowing the at least one member to modify the display of the record corresponding to the uniquely identifiable item.

12. The method of claim 11, further comprising allowing the at least one member to initiate a request for authentication of the uniquely identifiable item by a third-party.

13. The method of claim 11, further comprising allowing the at least one member to provide access to one or more documents relating to the uniquely identifiable item to a third-party.

14. The method of claim 11, further comprising allowing the at least one member to contact a sales agent via the computer network to initiate a sale of the uniquely identifiable item.

15. The method of claim 14, wherein the initiation of the sale of the uniquely identifiable item comprises automatically populating at least one field on an Internet site of the sales agent.

16. The method of claim 11, further comprising allowing the at least one member to identify the uniquely identifiable item as lost or stolen.

17. The method of claim 11, further comprising allowing the at least one member to request insurance coverage from an insurance provider via the computer network for the uniquely identifiable item.

18. The method of claim 11, wherein the modification of the display of the record comprises having the background of the display of the record flash two or more different colors.

19. The method of claim 11, wherein the modification of the display of the record is terminated substantially immediately in response to a termination request received from the at least one member.

20. The method of claim 11, wherein:
the display of the record corresponding to the uniquely identifiable item includes a status designation; and
the modification of the display of the record comprises changing the status designation for the record to indicate a flashing of ownership.
